(19) United States
(12) Patent Application Publication
(10) Pub. No.: US 2007/0251465 A1
(43) Pub. Date: Nov. 1, 2007

(54) Pet container

(75) Inventors: Adam Robert George Shafer, Morrow, OH (US); Barry Stanley Shantz, Cincinnati, OH (US); Gary I. Voss, Medina, OH (US); James Christopher Dorn, Norton, OH (US); James Edward McCay, Fairfield, CT (US); Guy Baskerville Wilkins, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Iams Company, Cincinnati, OH (US)

(21) Appl. No.: 11/717,371

(22) Filed: Mar. 13, 2007

Related U.S. Application Data
(60) Provisional application No. 60/781,793, filed on Mar. 13, 2006.

(51) Int. Cl. A01K 1/03

(52) U.S. Cl. 119/497

(57) ABSTRACT

The present invention is a pet container that has a base having at least two legs. The container has a tip angle of from about 10° to about 50°.

### CROSS REFERENCE TO RELATED APPLICATIONS

This application claims benefit of U.S. Provisional No. 60/781,793, filed on Mar. 13, 2006.

### CROSS TECHNICAL FIELD

The present invention relates to a pet container comprising a base comprising at least two legs wherein said container has a tip angle of from about 10° to about 50°.

### BACKGROUND OF THE INVENTION

Pet containers are well known and widely used for holding pet compositions or products and dispensing the product or composition to a target receptacle. Most pet containers are shaped as a rectangle, a square or contained in some type of bag made of paperboard or layers of kraft paper. During dispensing, the pet containers are difficult to control and manage and are visually bulky and unappealing.

Attempts at producing pet containers that have round surfaces have resulted in containers that easily tip, jumble on a manufacturing line, cause difficulty in transportation of the pet containers.

Thus, a need still exists for a pet container that is easy to manage and control during dispensing of the composition contained in the container, are visually appealing, avoid tipping, or jumbling during manufacturing of the container and allows increased ease of transporting the container.

It is therefore an object of the present invention to provide a pet container that comprises a base comprising at least two legs where in the container has a tip angle from about 10° to about 50°. The legs prevent tipping and the shape of the container prevents jumbling on a manufacturing line and prevents problems during transportation. The container is visually appealing and can comprise round surfaces. Additionally the container can comprise a handle which aids in ease of dispensing and ease of manipulation of the container during dispensing

### SUMMARY OF THE INVENTION

The present invention relates to a pet container comprising: comprising a base comprising at least two legs; and wherein said container has a tip angle of from about 10° to about 50°.

The present invention further relates to a pet container comprising: comprising a base comprising at least three legs; and wherein said container has a tip angle of from about 10° to about 50°.

The present invention further relates to a pet container comprising: comprising a base comprising at least four legs; and wherein said container has a tip angle of from about 10° to about 50°.

The present invention is also directed to a method of dispensing pet composition from said container into a target receptacle.

The present invention is also directed to an article of commerce comprising (a) a pet container having a base with two legs; (b) a pet composition contained in said container having a base with two legs; and (c) a set of instructions in association with said container comprising instructions to open, pour and close said container; and wherein said container allows for easy dispensing of said composition.

The present invention is also directed to a pet kit comprising: (a) an article of commerce comprising a pet container comprising base and two legs and a pet composition contained in the container; and (b) a handle.

### BRIEF DESCRIPTION OF THE DRAWINGS

FIG. 1 is a perspective view of a pet container of the present invention.

FIG. 2 is a bottom view of the pet container of FIG. 1.

FIG. 3 is a perspective view of a pet container of the present invention.

FIG. 4 is a bottom view of the pet container of FIG. 3.

FIG. 5 is a perspective view of a pet container of the present invention.

FIG. 6 is a bottom view of the pet container of FIG. 5.

FIG. 7 is a perspective view of a pet container of the present invention.

FIG. 8 is a left side view of the pet container of FIG. 7.

FIG. 9 is a bottom view of pet container of FIG. 7.

FIG. 10 is a right side view of a pet container of the present invention.

FIG. 11 is a left side view of a pet container of FIG. 10.

FIG. 12 is a bottom view of the pet container of FIG. 10.

FIG. 13 is a perspective view of a pet container comprising a orifice cover of the present invention.

FIG. 14 is a top view of the pet container of FIG. 13.

FIG. 15 is a bottom view of the pet container of FIG. 13.

FIG. 16 is a perspective view of a rotating cover of the present invention.

FIG. 17 is a side view of the rotating cover of FIG. 16.

FIG. 18 is a top view of the rotating cover of FIG. 16.

FIG. 19 is a perspective view of a snap cover of the present invention.

FIG. 20 is a side view of the rotating cover of FIG. 19.

FIG. 21 is a top view of the rotating cover of FIG. 19.

### DETAILED DESCRIPTION OF THE INVENTION

All percentages and ratios used herein are by weight of the total composition and all measurements made are at 25° C., unless otherwise designated.

As used herein, the term “companion animal” means a domestic animal preferably including (for example) dogs, cats, horses, cows, pigs, rabbits, and the like. Domestic dogs and cats are particularly preferred.

As used herein, the term “integral” or “integrally formed” means a part is smoothly continuous in form and that any components making up the part have been rendered inseparable.

As used herein, the term “pet composition” means a composition that can be ingestioned by a companion animal, a toy for a companion animal, supplements for a companion animal, shampoos, conditioners, a composition for eliminating waste from a companion animal and combinations thereof. The pet composition can be wet, moist, and/or dry.

Pet Container

The pet container of the present invention comprises a base comprising at least two legs. The preferred pet container is a blow molded plastic container whereby the base and legs are formed integrally into the container at the time of manufacture. However, the legs can be added to the pet container after manufacturing. The pet containers can have labels added during the in manufacturing process.

The pet container may include multiple layers. Suitable materials for the pet container comprise but are not limited to High Density Polyethylene (HDPE), Linear Low Density Polyethylene (LLDPE), Low Density Polyethylene (LDPE), Polyethylene (PE), Medium Density Polyethylene (MDPE), Polyethylene Terephthalate (PET), Glycol-modified Polyethylene Terephthalate (PETG), Polypropylene (PP), Polystyrene (PS), Polyethylene (PE), Oriented Polystyrene (OPS), Oriented Polypropylene (OPP), Thermoplastic Elastomer (TPE), Polyvynlchloride (PVC), Polyvynlidene Chloride (PVDC), Nylon, Polyester, Polyethylene Terphthalate Polyester (PETP), Thermoplastic Elastomer (TPE), Thermoplastic Rubber (TPR), metalized films, Ethylene vynl alcohol copolymer (EVOH), and combinations thereof. The pet container may be comprised of transparent, translucent, or opaque materials.

The pet container may have any geometric shape including square, rectangle, round, oval, tetrahedral configurations and combinations thereof. The pet container may include tubes, bottles, or pouches.

The pet container comprises a base. The base is located on the side of the container that rests on a hard surface. The base is integral with the pet container. The base comprises preferably at least two legs, preferably at least 3 legs, preferably at least 4 legs. Suitable materials for the legs comprise but are not limited to HDPE, LLDPE, LDPE, PE, MDPE, PET, PETG, PP, PS, OPS, OPP, TPE, PVC, PVDC, Nylon, Polyester, PETP, metalized films, EVOH, PE, TPE, TPR, and combinations thereof.

Preferably the legs extend from the base of the pet container. The legs can extend from the base at different angles and positions. The legs can be integrally formed with the pet container or they can be attached after the base of the pet container has been formed. The legs provide support for the container and allow the container to sit in an upright position with out tipping or falling over. Additionally, the legs can provide support to the user during dispensing of the pet composition. The legs may be any color, including but not limited to red, orange, yellow, green blue, purple. The legs may match the color of the orifice cover, the pet container, or the handle.

The pet container has a tip angle from about 10° to about 50°, preferably from about 15° to about 45°, more preferably from about 20° to about 40°, even more preferably from about 25° to about 35°, and still more preferably from about 28° to about 30°, as determined by the Tip Angle Method described hereafter.

The pet container can further comprise an orifice which comprises an orifice cover which serves to cover the orifice to prevent accidental dispensing of the pet composition, e.g. during shipment of the article of commerce or pet container to retail stores or between uses. The orifice cover can be a removable cover, slider cover, a push/pull cover, a rotating cover, a snap cover, swing cover, and the cover can be hinged or non-hinged. In some embodiments where the orifice cover is a removable cover, the consumer can remove and discard the orifice cover, upon initial use of the pet container. In such embodiments, the consumer can then dispense the composition by simply grasping the pet container and tipping the pet container and dispense the composition from the pet container.

The pet container can further comprise a handle which aids in dispensing the pet composition. The handle provides support during dispensing of the pet composition and a means of easily grasping and carrying the pet container. The handle can be integrally formed with the pet container or it can be attached after the pet container has been formed. The handle can be located in various places on the pet container. The handle can be attached to one end of the container, separate from the container; removable from the container, an integral part of the container, disconnected from one area of the container and then reconnected in another area of the container.

Suitable materials for the handle comprise but are not limited to HDPE, LLDPE, LDPE, PE, MDPE, PET, PETG, PP, PS, OPS, OPP, TPE, PVC, PVDC, Nylon, Polyester, PETP, metalized films, EVOH, PE, TPE, TPR, and combinations thereof.

The handle can be various shapes and sizes. The handle can have any geometric shape including square, rectangle, round, oval, tetrahedral configurations and combinations thereof. The handle may be transparent, translucent, opaque or mixtures or transparent, translucent, and opaque. The handle may be any color, including but not limited to red, orange, yellow, green blue, purple. The handle may match the color of the orifice cover, the pet container, or the legs.

Article of Commerce

The present invention encompasses articles of commerce illustrated in FIG. X. The article of commerce comprising (a) a pet container having a base with two legs; (b) a pet composition contained in said container having a base with two legs; and (c) a set of instructions in association with said container comprising instructions to open, pour and close said container; and wherein said container allows for easy dispensing of said composition.

The efficacy of the current invention can be linked to the ability of the consumer to understand the usage instructions and to use the product accordingly. The article of commerce can further comprise a set of instructions in association with the pet container which instruct a consumer to carry out the methods of the present invention. These instructions may comprise illustrations.

Pet Kit

The present invention can also comprise a pet kit. The pet kit of the present invention can comprise: (a) an article of commerce comprising a pet container comprising a base and at least two legs wherein said container has a tip angle of from about 100 to about 50 and a pet composition contained in the container; and (b) a handle. The pet kit may further comprise an additional pet composition in a full size, a sample size or both. The pet kit may further comprise an additional pet composition that coordinates with the pet composition that is comprised within the pet container or attached to the outside of the pet container. For, example if the pet composition contained in the pet container is a dry pet food, the coordinating pet composition may be for a gravy. As well, if the pet composition in the pet container is a pet shampoo, the coordinating pet composition may be a pet conditioner. As well, if the pet composition in the pet container is a pet food, the coordinating pet composition may be a probiotic, or vitamin, or raw hide, or treats, or chews. The pet kit may further comprise a coupon, rebate, or advertisement. The pet kit may further comprise a grooming device, selected from the group consisting of a cleansing cloth, disposable cleansing cloth, a brush, a comb, and combinations thereof.

The pet kit may further comprise a set of instructions. These instructions may also include illustrations.

### Method of Use

The present invention also relates to a method of dispensing pet composition from said container into a target receptacle, the method comprising the steps of: (a) removing the orifice cover from the orifice of a pet container; (b) dispensing a pet composition from said pet container comprising a base comprising at least two legs; and (c) closing said pet container with said orifice cover.

The pet container can further comprise a handle, wherein handle allows the user to grasp the handle and then dispense the composition from the pet container. Additionally, the legs can aid in tipping the pet container to dispense the pet composition.

### Pet Compositions

The pet composition of the present invention can be pet food, dog food, cat food, treats, biscuits, kitty liter, catnip, toys, raw hide, shampoos, conditioners, treats, probiotics, vitamins, chews, fillers and combinations thereof. The pet compositions may be wet, moist and/or dry. The animal food composition of the present invention can be a moist pet composition (i.e. those having a total moisture content of from about 16% to 50%, by weight of the product), and/or a wet pet composition (i.e. those having a total moisture content of greater than 50%, by weight of the product), and/or dry pet composition (i.e. those having a total moisture content of from about 0% to about 16%, by weight of the product). Unless otherwise described herein, wet pet composition, moist pet composition and/or dry pet composition are not limited by their composition or method of preparation.

As an example, in one embodiment the pet composition is nutritionally balanced. As used herein, the term “nutritionally balanced,” with reference to the companion animal composition, means that the composition has known required nutrients to sustain life in proper amounts and proportion based on recommendations of recognized authorities in the field of companion animal nutrition. Nutritionally balanced compositions are widely known and widely used in the art.

Nonlimiting examples of dry pet compositions may optionally contain from about 1% to about 50% crude protein, from about 0.5% to about 25% crude fat, from about 1% to about 10% crude fiber, and from about 1% to about 30% moisture, all by weight of the pet composition. In a further embodiment of the present invention, a pet composition may contain from about 5% to about 35% crude protein, from about 5% to about 25% crude fat, from about 1% to about 5% crude fiber, and from about 2% to about 20% moisture, all by weight of the pet composition. In another embodiment of the present invention, a pet composition is a dry pet composition that contains a minimum protein level of about from about 9.5% to about 22%, a minimum fat level of from about 8% to about 13%, a minimum moisture level of from about 3% to about 8%, a minimum fiber level of from about 2% to about 3%, a carbohydrate level of from about 0% to about 40%, all by weight of the pet composition. The dry pet composition may also have a minimum metabolizable energy level of about 3.5 Kcal/g.

Nonlimiting examples of a moist pet composition may optionally contain from about 0.5% to about 50% crude protein, from about 0.5% to about 25% crude fat, from about 0.5% to about 15% crude fiber, from about 30% to about 50% moisture, all by weight of the pet composition. In another embodiment, moist pet compositions may contain from about 5% to about 35% crude protein, from about 5% to about 25% crude fat, from about 1% to about 5% crude fiber, and from about 35% to about 45% moisture, all by weight of the pet composition. In another embodiment of the present invention, a pet composition is a moist pet composition that a minimum protein level of about from about 9.5% to about 22%, a minimum fat level of from about 8% to about 13%, a minimum moisture level of about 38% to about 42%, a minimum fiber level of from about 2% to about 3%, a carbohydrate level of from about 0% to about 40%, all by weight of the pet composition. The moist pet composition may also have a minimum metabolizable energy level of about 3.5 Kcal/g and from about 0.1% to about 20% ash, and from about 0.001% to about 5.0% taurine.

Nonlimiting examples of a wet pet composition may optionally contain from about 0.5% to about 50% crude protein, from about 0.5% to about 25% crude fat, from about 0.5% to about 15% crude fiber, from about 50% to about 90% moisture, all by weight of the pet composition. In another embodiment, wet pet compositions may contain from about 5% to about 35% crude protein, from about 5% to about 25% crude fat, from about 1% to about 5% crude fiber, and from about 60% to about 85% moisture, all by weight of the pet composition. In another embodiment of the present invention, a pet composition is a wet pet composition that contains a minimum protein level of about from about 9.5% to about 22%, a minimum fat level of from about 8% to about 13%, a moisture level of from about 65% to about 80%, a minimum fiber level of from about 2% to about 3%, a carbohydrate level of from about 0% to about 40%, all by weight of the pet composition. The wet pet composition may also have a minimum metabolizable energy level of about 3.5 Kcal/g and from about 0.1% to about 20% ash, and from about 0.001% to about 5.0% taurine.

In one embodiment of the present invention, a pet composition is a pet composition, whether dry, moist, wet, or otherwise, that comprises from about 5% to about 50%, alternatively 20% to about 50% of animal-derived ingredients, by weight of the pet composition. Non-limiting examples of animal-derived ingredients include chicken, beef, pork, lamb, turkey (or other animal) protein or fat, egg, fishmeal, and the like.

In one embodiment of the present invention, a pet composition is a filler. The filler can be a solid, a liquid or packed air. The filler can be reversible (for example thermo-reversible including gelatin) and/or irreversible (for example thermo-irreversible including egg white). Nonlimiting examples of the filler include gravy, gel, jelly, aspic, sauce, water, air (for example including nitrogen, carbon dioxide, and atmospheric air), broth, and combinations thereof.

The filler can optionally further comprise an additional component. Nonlimiting examples of additional components include wheat protein, soy protein, lupin protein, protein flour, textured wheat protein, textured soy protein, textured lupin protein, textured vegetable protein, breading, comminuted meat, flour, comminuted pasta, pasta, water, flavorants, starches, seasoning salts, colorants, time-release compounds, minerals, vitamins, antioxidants, prebiotics, probiotics, aroma modifiers, flavor modifiers, and combinations thereof.

Where the pet composition is in the form of a gravy, the composition preferably comprises at least 10% of a broth, or stock, non-limiting examples of which include vegetable beef, chicken or ham stock. Typical gravy compositions may comprise from about 0.5% to about 5% crude protein, from about 2% to about 5% crude fat, and from about 1% to about 5% fiber.

In another embodiment, pet compositions can be in the form of a supplement composition such as biscuits, chews, and other treats that may comprise, on a dry matter basis, from about 20% to about 60% protein, or from about 22% to about 40% protein, by weight of the supplement composition. As another example, the supplement compositions may comprise, on a dry matter basis, from about 5% to about 35% fat, or from about 10% to about 30% fat, by weight of the supplement composition. Food and supplement compositions intended for use by canines or felines are commonly known in the art.

In one embodiment of the present invention, a pet composition is a cat litter. The litter can be composed of a number of different materials. Nonlimiting examples include bentonite clay, silica gel, ground grain (such as wheat, ground corn cob, whole corn, partially gelatinized corn, ground corn, derivative forms of corn, derivative forms of corn from thermomechanical processing such as extrusion, citrus peel, ground citrus peel, a derivative of citrus peel, processed ground citrus peel), a cellulosic hull material (cereal grain hulls, peanut hulls, soybean, rapeseed, sunflower, or cottonseed hulls) in combination with a nitrogenous compound absorber (cyclodextrin), wood, sawdust, citrus pulp/fiber, processed paper such as newspaper, rice, fruit or vegetable pulp or skins, nut or bean shells (e.g., peanut shells, cocoa shells, etc.), and cellulosic portions of herbaceous plants (e.g., stems, leaves), plant pulp, a polyacrylate polymer (polyglycerol acrylate or polypropyl acrylate), a hydrogel-forming polymer, such as AGM by itself or in combination with whole corn, partially gelatinized corn, ground corn, derivative forms of corn, derivative forms of corn from thermomechanical processing such as extrusion, citrus peel, ground citrus peel, a derivative of citrus peel, processed ground citrus peel. The litter absorbs nitrogenous waste and absorb feline urine and allow the cat to bury its feces

The litter may also comprise one or more of the following: pre-gel starch, odor-reducing agents, indicators, antimicrobial agents, and antifungal agents. The high-capacity absorption material may be an absorbent material that absorbs aqueous liquids at least two to preferably more than five times its own weight.

In one embodiment of the present invention, a pet composition is a pet composition that may contain, but is not limited to, a component selected from the group consisting of chicken, ground corn, poultry fat, grain sorghum, brewers rice, fish meal, beet pulp, flavor digest, dried egg, dicalcium phosphate, potassium chloride, brewer's yeast, ground flax, sodium chloride, menhaden oil, and mixtures thereof. In a further embodiment, the pet composition contains two or more, three or more, four or more, or five or more of these components.

The compositions of the present invention may further comprise a source of carbohydrate. Grains or cereals such as rice, corn, milo, sorghum, barley, wheat, and the like are illustrative sources.

The pet compositions may also contain other materials such as dried whey and other dairy by products.

The pet compositions of the present invention can further comprise a wide range of other optional ingredients. These optional ingredients can be present as part of the pet composition.

Nonlimiting examples of optional ingredients can include at least one vegetable. Nonlimiting examples of vegetables include carrots, peas, potatoes, cabbage, celery, beans, corn, tomatoes, broccoli, cauliflower, leeks and combinations thereof.

Nonlimiting examples of additional components include wheat protein, soy protein, lupin protein, protein flour, textured wheat protein, textured soy protein, textured lupin protein, textured vegetable protein, breading, comminuted meat, flour, comminuted pasta, pasta, water, flavorants, starches, seasoning salts, colorants, time-release compounds, minerals, vitamins, antioxidants, prebiotics, probiotics, aroma modifiers, flavor modifiers, and combinations thereof.

The compositions may also comprise at least one fiber source for improved gastrointestinal health. Such fiber sources may comprise, for example, at least one moderately fermentable fiber. Moderately fermentable fiber has previously been described to provide a benefit to the immune system of a companion animal. Moderately fermentable fiber or other compositions known to those of skill in the art which provide a prebiotic composition to enhance the growth of probiotic microorganisms within the intestine may also be incorporated into the composition to aid in the enhancement of the benefit provided by the present invention to the immune system of an animal. Additionally, probiotic microorganisms, such as Lactobacillus or Bifidobacterium species, for example, may be added to the composition or the pet compositions themselves.

The compositions of the present invention may also comprise a prebiotic. “Prebiotic” includes substances or compounds that are fermented by the intestinal flora of the pet and hence promote the growth or development of lactic acid bacteria in the gastro-intestinal tract of the pet at the expense of pathogenic bacteria. The result of this fermentation is a release of fatty acids, in particular short-chain fatty acids in the colon. This has the effect of reducing the pH value in the colon. Non-limiting examples of suitable prebiotics include oligosaccharides, such as inulin and its hydrolysis products commonly known as fructooligosaccharides, galacto-oligosaccarides, xylo-oligosaccharides or oligo derivatives of starch. The prebiotics may be provided in any suitable form. For example, the prebiotic may be provided in the form of plant material which contains the fiber. Suitable plant materials include asparagus, artichokes, onions, wheat or chicory, or residues of these plant materials. Alternatively, the prebiotic fiber may be provided as an inulin extract, for example extracts from chicory are suitable. Suitable inulin extracts may be obtained from Orafti SA of Tirlemont 3300, Belgium under the trade mark “Raftiline”. For example, the inulin may be provided in the form of Raftiline (g) ST which is a fine white powder which contains about 90 to about 94% by weight of inulin, up to about 4% by weight of glucose and fructose, and about 4 to 9% by weight of sucrose. Alternatively, the fiber may be in the form of a fructooligosaccharide such as obtained from Orafti SA of Tirlemont 3300, Belgium under the trade mark “Raftilose”. For example, the inulin may be provided in the form of Raftilose (g) P95. Otherwise, the fructooligosaccharides may be obtained by hydrolyzing inulin, by enzymatic methods, or by using micro-organisms.

Also useful herein, as an optional ingredient, is one or more colorants. Nonlimiting examples of colorants include, but are not limited to, synthetic or natural colorants, and any combination thereof.

Also useful herein, as an optional ingredient, is at least one fruit. Nonlimiting examples include tomatoes, apples, avocado, pears, peaches, cherries, apricots, plums, grapes, oranges, grapefruit, lemons, limes, cranberries, raspberries, blueberries, watermelon, cantelope, mushmellon, honeydew melon, strawberries, banana, and combinations thereof.

The pet foods may contain other active agents such as long chain fatty acids and zinc. Suitable long chain fatty acids include alpha-linoleic acid, gamma linolenic acid, linoleic acid, eicosapentanoic acid, and docosahexanoic acid. Fish oils are a suitable source of eicosapentanoic acids(EPA) and docosahexanoic acid (DHA). In one embodiment of the present invention, a pet composition is a pet composition wherein the DHA level is at least about 0.05%, alternatively at least about 0.1%, alternatively at least about 0.15% of the pet composition, all by weight of the pet composition. In another embodiment of the present invention, a pet composition is a pet composition wherein the DHA level is from about 0.05% to about 0.25% of the pet composition, by weight of the pet composition. In another embodiment of the present invention, a pet composition is a pet composition wherein the DHA level is from about 0.07% to about 0.18% of the pet composition, by weight of the pet composition. In one embodiment of the present invention, a pet composition is a pet composition wherein the EPA level is at least about 0.05%, alternatively at least about 0.1%, alternatively at least about 0.15% of the pet composition, all by weight of the pet composition. In another embodiment of the present invention, a pet composition is a pet composition wherein the EPA level is from about 0.05% to about 0.25% of the pet composition, by weight of the pet composition. In another embodiment of the present invention, a pet composition is a pet composition wherein the EPA level is from about 0.07% to about 0.15% of the pet composition, by weight of the pet composition.

In an embodiment of the present invention, a pet composition is a shampoo composition comprising surfactants, nonlimiting examples include anioninc, cationic, nonionic, amphoteric, zwitterionic, and combinations thereof. Other suitable surfactants are described in McCutcheon's, Emulsifiers and Detergents, 1989 Annual, published by M. C. Publishing Co., and in U.S. Pat. No. 3,929,678.

One embodiment comprises from about 5.0% to about 50% of an anionic surfactant, from about 0.1% to about 15% of an amphoteric surfactant; from about 0.01% to about 5%, by weight, of a water soluble, cationic polymer hair conditioning agent, and an aqueous carrier.

Non limiting examples of optional components for use in the shampoo composition or used in a separate pet composition or used in combination with the shampoo composition include anti dandruff agents, conditioning agents (hydrocarbon oils, fatty esters, silicones) dyes, nonvolatile solvents or diluents (water soluble and insoluble), pearlescent aids, foam boosters, additional surfactants or nonionic cosurfactants, pediculocides, pH adjusting agents, perfumes, preservatives, proteins, skin active agents, sunscreens, vitamins, and viscosity adjusting agents, anti-tick, anti-flea, skin soothing agents.

### Methods of Manufacturing

For dried pet compositions a suitable process is extrusion cooking, although baking and other suitable processes may be used. When extrusion cooked, the dried pet food is usually provided in the form of a kibble.

For wet and moist pet compositions, the processes described in U.S. Pat. Nos. 4,781,939 and 5,132,137 may be used to produce simulated meat products. Other procedures for producing chunk type products may also be used; for example cooking in a steam oven. Alternatively, loaf type products may be produced by emulsifying a suitable meat material to produce a meat emulsion, adding a suitable gelling agent, and heating the meat emulsion prior to filling into the container of the present invention.

Nonlimiting Embodiments of The Pet Container

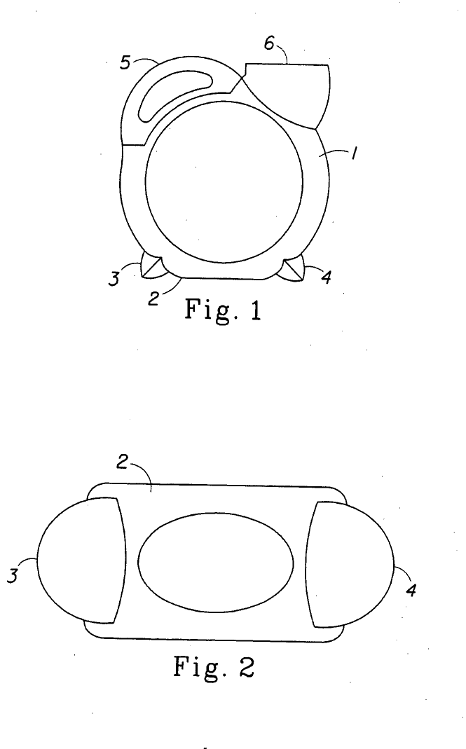

The present invention encompasses a pet container 1 as illustrated in FIG. 1-21. Each of the following pet container embodiments can contain a pet composition located in the container.

FIG. 1 illustrates one possible embodiment of a pet container 1 comprising a base 2 having a first leg 3 and a second leg 4. The container also comprises a handle 5 and an orifice 6 in which the pet composition can be dispensed from. FIG. 2 illustrates the bottom view of the pet container 1 of FIG. 1 comprising a base 2 and a first leg 3 and a second leg 4.

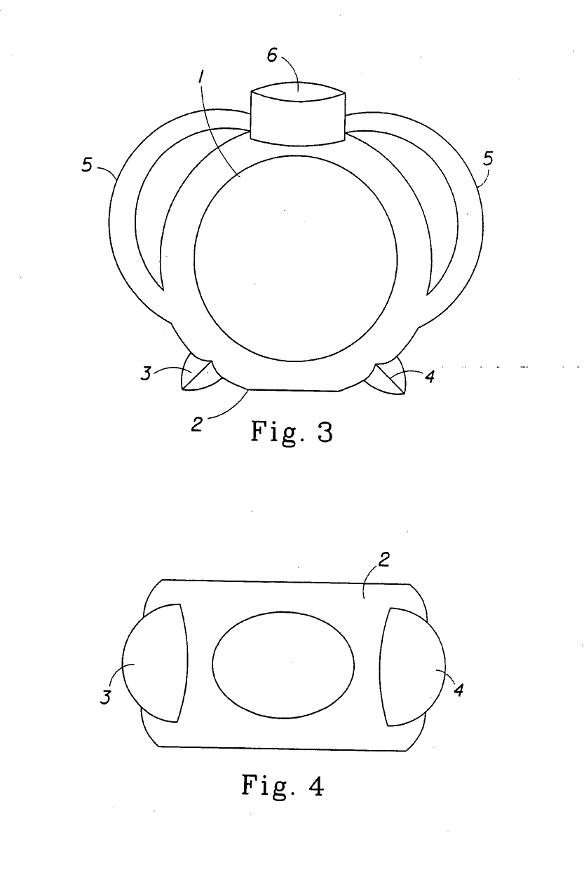

FIG. 3 illustrates one possible embodiment of a pet container 1 comprising a base 2 having a first leg 3 and a second leg 4. The container comprises two handles 5 and an orifice 6 in which the pet composition can be dispensed from. FIG. 4 illustrates the bottom view of the pet container 1 of FIG. 3 comprising a base 2 and a first leg 3 and a second leg 4.

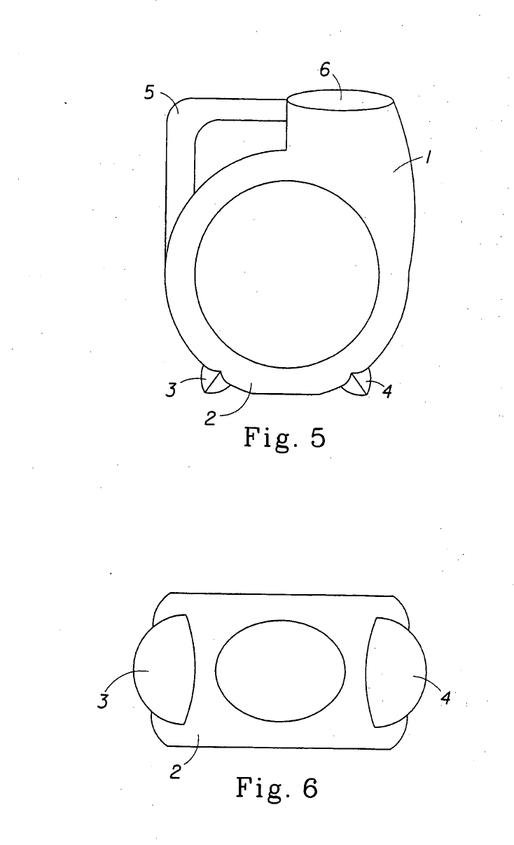

FIG. 5 illustrates one possible embodiment of a pet container 1 comprising a base 2 having a first leg 3 and a second leg 4. The container comprises a handle 5 and an orifice 6 in which the pet composition can be dispensed from. FIG. 6 illustrates the bottom view of the pet container 1 of FIG. 5 comprising a base 2 and a first leg 3 and a second leg 4.

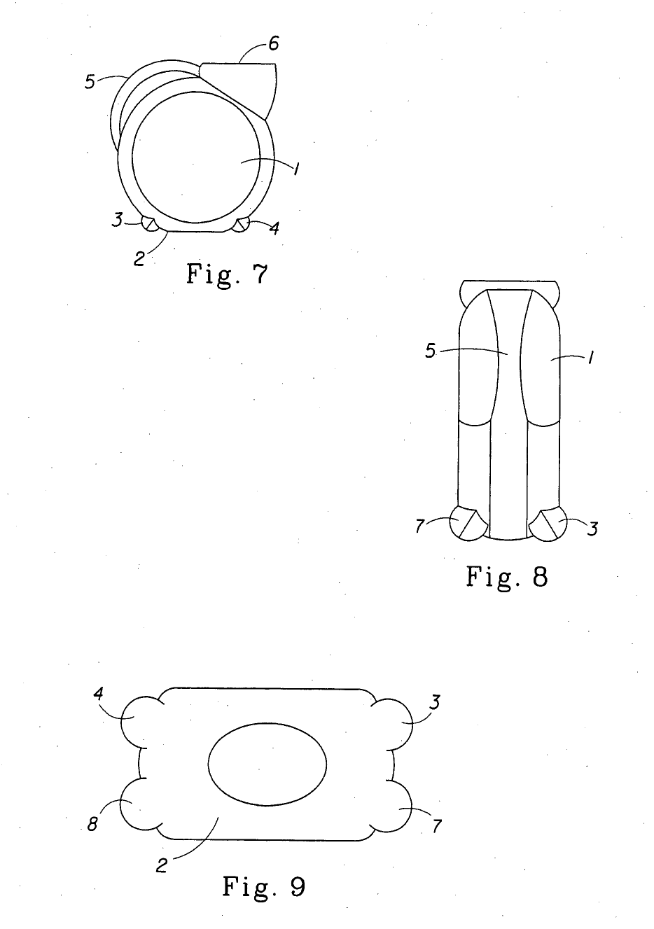

FIG. 7 illustrates one possible embodiment of a pet container 1 comprising a base 2 having a first leg 3, a second leg 4, a third leg 7, and a fourth leg 8. The container comprises a handle 5 and an orifice 6 in which the pet composition can be dispensed from. FIG. 8 illustrates the left side view of the pet container 1 of FIG. 7 comprising a first leg 3, a third leg 7, and a handle 5. FIG. 9 illustrates the bottom view of the pet container 1 of FIG. 7 comprising a base 2 and a first leg 3, a second leg 4, a third leg 7, and a fourth leg 8.

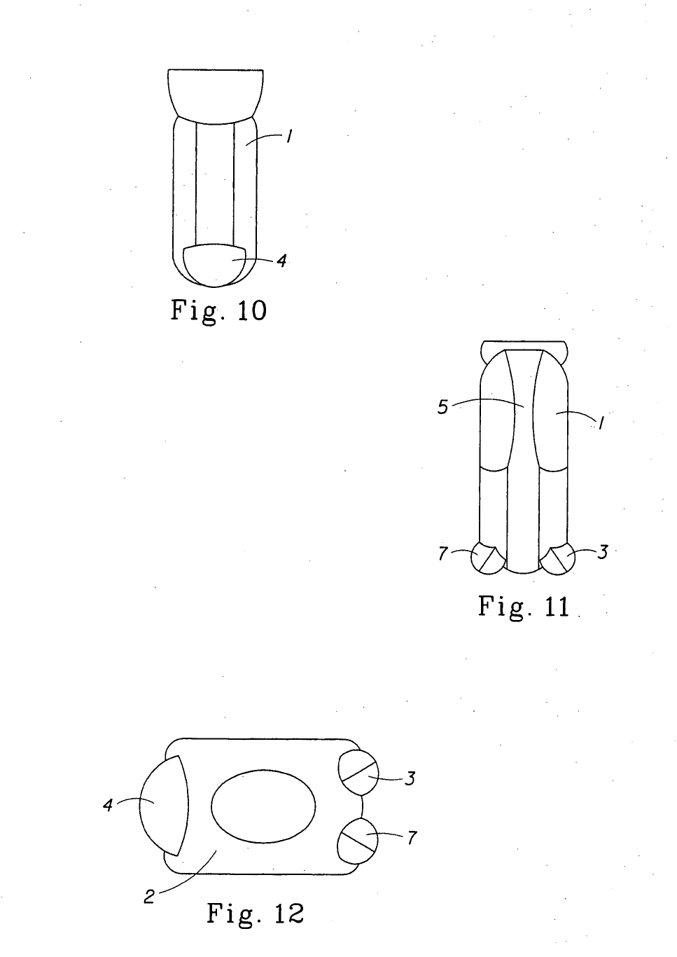

FIG. 10 illustrates the right side view of a pet container 1 comprising a second leg 4. FIG. 11 illustrates the left side view of the pet container 1 comprising a first leg 3, a third leg 7, and a handle 5. FIG. 12 illustrates the bottom view of the pet container 1 comprising a base 2 and a first leg 3, a second leg 4, and a third leg 7.

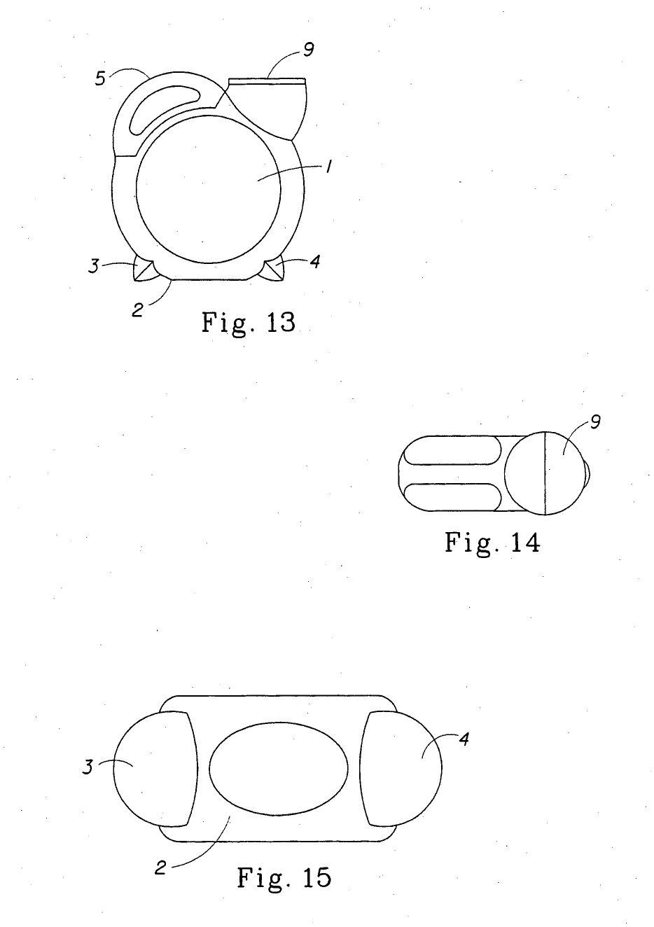

FIG. 13 illustrates one possible embodiment of a pet container 1 comprising a base 2 having a first leg 3 and a second leg 4. The container also comprises a handle 5, and an orifice cover 9 in which can be removed and the pet composition can be dispensed. FIG. 14 illustrates a top view of the pet container 1 comprising an orifice cover 9. FIG. 15 illustrates the bottom view of the pet container 1 of FIG. 13 comprising a base 2 and a first leg 3 and a second leg 4.

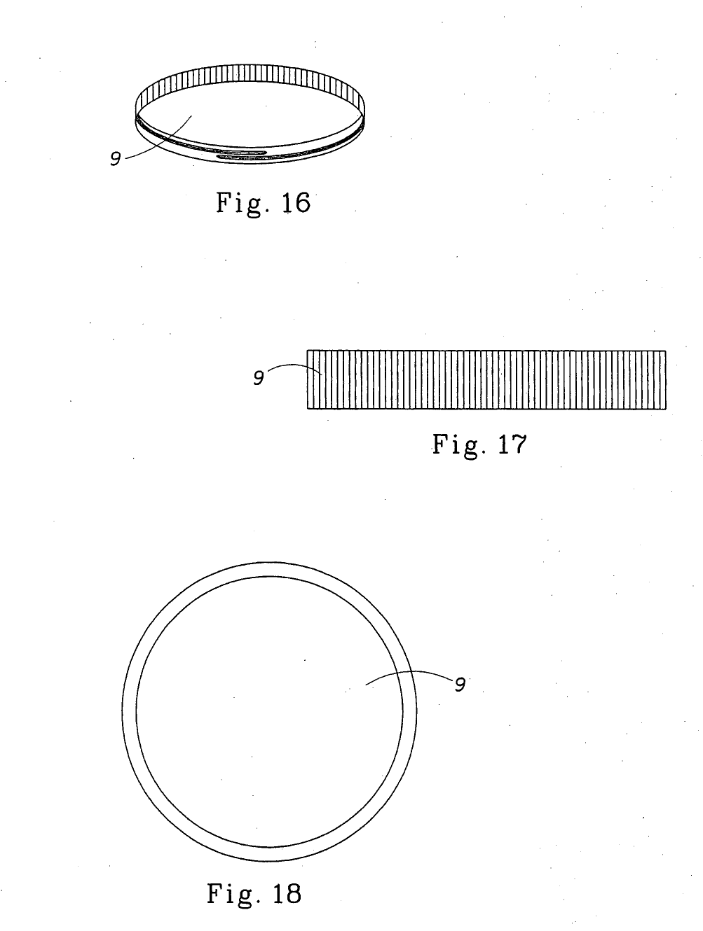

FIG. 16 illustrates a perspective view of a rotating cover 9 that can be used with the pet container 1 of the present invention. FIG. 17 is a side view of a rotating cover 9. FIG. 18 is a top view of a rotating cover 9.

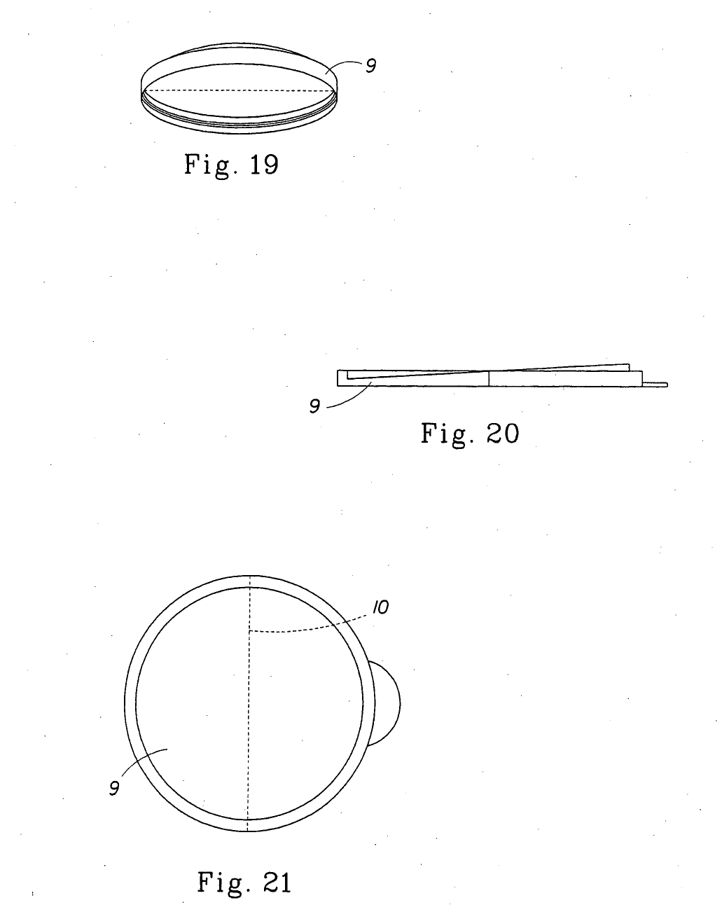

FIG. 19 illustrates a perspective view of a snap cover 9 that can be used with the pet container 1 of the present invention. FIG. 20 is a side view of a snap cover 9. FIG. 21 is a top view of a rotating cover 9. The snap cover can comprise a hinge 10.

Tip Angle Method

The Tip Angle Method is used to determine the tip angle of a pet container and is reported in degrees (°). The following Equipment is used to perform the Tip Angle Method.
1. Tilting Platform—made out of 3/16″ aluminum, measuring 9″×15″.
2. Sand paper—covering the surface of the tilting platform to prevent slipping prior to the container tipping.
3. Sensor (Made by Micro Switch)—model PC11-AG1—the sensor is positioned so that the platform stops when the pet container begins too tip. Sensor used to stop the tilting table once the container has tipped over.
4. Measuring Stick—mounted to the side of the tiling table calibrated to measure the angle of the table at the point where the container tips.
5. Motor—(Made by Dayton Gearmotor)—model 2Z797—Motor used to move the tilting platform up and down.
6. Differential—(made by Electroid)—model PCB.260.90V.T—used to convert the rotational power from the motor into a lifting power that will push the titling table up and down.

A sample pet container is obtained and is filled to the specified capacity of the container with 68 degrees F. water and hand capped with tightly applied orifice covers.

### Tip Angle Method Steps

A. Plug in the tilt machine and zero in the bubble levels to level the tester.

B. Check the angle indicator to confirm that the tilting platform is at the 0 degrees position.

C. Adjust the platform raise motor speed control dial to #6. This setting is equal to a 1 degree per second rise of the platform.

D. Flip switch #1 (electric eye beam) up. Position bottle so that the trailing bottle edge just interrupts the light beam. A slight “click” sound is produced when test sample is positioned between the electric eye beam. (When testing clear containers, position a piece of masking tape to just block eye beam.)

E. Flip switch #2 up and hold for a second. The platform will rise at the preset 1 degree per second rate, then will stop at the angle at which the bottle topples out of the crossbeam of the electric eye.

F. Record the tip angle reading directly from angle indicator.

G. Return the platform to a 0 degree position by pressing switch #3 down.

H. Repeat Steps A-G for any additional pet containers that need to be tested.

### Tip Angle=tip angle reading from angle indicator (°)

### Total Moisture Content Method

The method involves the analysis of the total moisture content in the pet composition. The analysis is based on the procedure outlined in AOAC method 930.15 and AACC method 44-19.

A pet composition sample is prepared by taking one unit volume, for example, 375 gram of the composition, and homogenizing in a food processor to a uniform consistency like a paste. An pet composition larger than 375 gram would be subdivided to create equal and representative fractions of the whole such that a 375 gram sample is obtained.

The paste of the pet composition is individually sampled in triplicate at a volume less than or equal to 100 ml and placed individually sealed in a 100 ml Nasco Whirl-Pak® (Fort Atkinson, Wis. 53538-0901). During the process of sealing the Whirl-Pak®, excess air is evacuated manually from the container just prior to final closure thereby minimizing the container headspace. The Whirl-Pak® is closed per manufacturer's instructions—tightly folding the bag over three (3) times and bending the tabs over 180 degrees.

All samples are refrigerated at 6° C. for less than 48 h prior to moisture analysis.

For total moisture analysis, the tare weight of each moisture tin and lid are recorded to 0.0001 g. Moisture tins and lids are handled using dry and clean forceps. Moisture tins and lids are held dry over desiccant in a sealed desiccator. A Whirl-Pak® containing a sample is unfolded and a 2.0000±0.2000 gram sample is weighed into the uncovered moisture tin. The weight of the sample in the moisture tin is recorded. The lid is placed atop the moisture tin in an open position to allow moisture loss but contain all other material during air oven drying. The lid and moisture tin loaded with sample are placed in an air oven operating at 135° C. for 6 h. Time is tracked using a count-down timer.

After drying, the tin is removed from the oven and the dried lid is placed atop the tin using forceps. The covered moisture tin with dried sample is placed immediately in a desiccator to cool. The sealed desiccator is filled below the stage with active desiccant. Once cool to room temperature, the covered moisture tin with dried sample is weighed to 0.0001 g and weight recorded. The total moisture content of each sample is calculated using the following formula:

Total Moisture Content (%)=100−(weight of tin, lid and sample after drying−empty tin and lid weight)×100/initial sample weight.

### EXAMPLES

The following examples further describe and demonstrate embodiments within the scope of the invention. The examples are given solely for the purpose of illustration and are not to be construed as limitations of the present invention, as many variations thereof are possible without departing from the spirit and scope of the invention. All exemplified amounts are concentrations by weight of the pet compositions, unless otherwise specified.

The following Examples can be contained in the pet container or attached to the outside of the pet container of the present invention:

### Example 1

The pet composition of the present invention can be a biscuit. A biscuit which may be utilized for any of Examples 2-5 may be prepared using the following components in the indicated amounts:

| Component | Amount (by weight percent) |
|---|---|
| Rosemary Extract | 0.1 |
| Emulsifier | 1 |
| Vegetable Oil | 1.5 |
| Beet Pulp (from sugar beet) | 4 |
| Potassium Sorbate | 0.05 |
| Dehydrated Parsley | 0.5 |
| Meat Flavor | 0.8 |
| Wheat Germ | 5 |
| Oats | 15 |
| Corn Meal | 15 |
| Chicken By-Product Meal | 20 |
| Whole Wheat Flour | Remainder |

### The components are combined, shaped as desired, and baked to form biscuits.

### Example 2

A mineral component is prepared by combining 2.19 g zinc sulfate monohydrate, 2.88 g manganese chloride tetrahydrate, and 0.79 g copper sulfate pentahydrate in a mortar and pestle. The powders are finely ground and thoroughly mixed. Savory masking flavor, at an amount of 3%, by weight, is added to the mineral component. A 12 gram baked dog biscuit is painted on one side with a 30% solution of corn syrup solids glazing (N-TACK®, commercially available from National Starch and Chemical Co., Bridgewater, N.J., U.S.A). The combination of mineral component and savory masking flavor is sprinkled onto the wet glazing in an amount of 121 milligrams of the combination per biscuit, and the glazing is dried.

### Example 3

50 grams of water is added to a beaker and stirred vigorously. 50 grams sodium polyphosphate is added, and stirring continues about 1 hour until a clear viscous solution is obtained. A 4 gram baked dog biscuit is dipped into the viscous solution and allowed to drain until about 400 mg solution remains. The biscuit is then dried in a 70° C. convection oven for about 20 minutes, and is then cooled to room temperature. Then, 6.59 grams zinc suflate monohydrate and 7.39 grams manganese sulfate monohydrate are combined in a mortar and pestle and finely ground. 20.96 grams granular mannitol (PEARLITOL 100 SD) is added to the mineral component using the principal of ordered mixing, and mixed thoroughly by trituration. The bottom side of the polyphosphate-coated biscuit is painted with a 30% water solution of corn syrup solids glazing (N-TACK®, commercially available from National Starch and Chemical Co., Bridgewater, N.J., U.S.A), and then the glazed side of the biscuit is pressed into a bed of the combination of mineral component and mannitol carrier. The biscuit is tapped to remove loosely held powder to leave about 67 mg powder. The biscuit is then dried in a 70° C. convection oven for about 20 minutes. Savory flavor is sprinkled on top of the powdered side of the biscuit.

### Example 4

44.4 grams water is added to a beaker and stirring is started. With constant stirring, 34.7 grams GLASS H polyphosphate is added and stirring is continued until a clear solution is obtained. To this solution the following are added: 2.72 grams zinc sulfate monohydrate, 3.06 grams manganese sulfate monohydrate, and 0.98 grams copper sulfate pentahydrate. Stirring is continued until a clear, blue-tinged solution is obtained. 4 gram baked dog biscuits are dipped into the solution and allowed to drain until about 500 mg solution is adhered to each biscuit. The biscuits are dried in a 70° C. convection oven for about 30 minutes.

### Example 5

48.5 grams water is added to a beaker. While stirring, 3 grams copper (II) gluconate is added. While stirring vigorously, 48.5 grams sodium polyphosphate (GLASS H) is sprinkled in, and stirring continues until a clear, blue tinted solution is obtained. 12 gram, paw-shaped dog biscuits are dipped into the solution of copper and phosphate component and allowed to drain until about 928 mg solution remains on the biscuit. Drying is carried out in a 70° C. convection oven for about 30 minutes. A coating powder is prepared by combining 2.63 grams zinc sulfate monohydrate and 2.96 grams manganese sulfate monohydrate in a mortar and pestle. These are finely ground. 8.39 grams granular mannitol is added using the standard principal of ordered mixing, and trituration with a spatula. 2.34 grams spray-dried chicken meat and 1.26 grams spray dried chicken liver are added to the powder and mixed until uniform. The bottom side of the biscuits are painted with a 30% water solution of corn syrup solids glazing (N-TACK®, commercially available from National Starch and Chemical Co., Bridgewater, N.J., U.S.A), and then the wet side is pressed into a bed of powder as described in the previous paragraph. The biscuits are placed powder side up on a tray and dried in a 70° C. convection oven for about 30 minutes. The total amount of powder applied per biscuit is approximately 293 milligrams.

### Example 6

The pet composition of the present invention can be a chew. A chew which may be utilized for Example 7 may be prepared using the following components in the indicated amounts:

| Component | Amount (by weight percent) |
|---|---|
| Sodium Tripolyphosphate | 1.8 |
| Rosemary Extract | 0.1 |
| Potassium Sorbate | 0.06 |
| Flavor | 0.6 |
| Vegetable Oil | 1.5 |
| Beet Pulp | 5 |
| Glycerin | 10 |
| Chicken by-product Meal | 10 |
| Wheat Flour | 23 |
| Soy Flour | Remainder |

The components are combined and extruded according to conventional methods as desired to form the chew. Optionally, the chew is prepared by combining all components except for the mineral component, extruding at high temperature, feeding glycerin continuously into a preconditioner until the proper consistency or texture is obtained. The product may then be cut to desired length and cooled. The chews may then be spray-coated with a suspension of the mineral component in any fat or oil. The following technique may be illustrative: A dispersion is prepared containing 3 grams of finely powdered zinc malate and 3 grams of finely powdered manganese malate in 100 grams refined liquid chicken fat. This dispersion is sprayed onto a 25 gram chew at a rate of 0.33 grams of the dispersion per chew.

### Example 7

Zinc sulfate monohydrate (2.20 g), manganese sulfate monohydrate (2.46 g), and copper sulfate pentahydrate (0.79 g) are combined in a mortar and pestle to a fine powder and triturated together. To this mixture is added 26.58 g granular mannitol carrier (PEARLITOL 100 SD, Roquette Corp.) using a standard pharmacy practice of ordered mixing. The granular mannitol carrier aids in masking the flavor of the mineral component and greatly enhances the dissolution of the minerals in saliva. A 4 gram extruded dog chew is painted on one side with a 30% solution of corn syrup solids glazing (N-TACK®, commercially available from National Starch and Chemical Co., Bridgewater, N.J., U.S.A). The wet side of the chew is pressed into the mixture of mineral component and mannitol carrier and any loose powder is gently tapped off. About 185 milligrams of material remains on the surface of the chew. The glazing solution is dried in a convection oven at 70° C. for about 20 minutes.

### Example 8-9

The pet composition of the present invention can be a kibble. Two kibble compositions having the following components at the approximate indicated amounts are prepared using methods which are standard in the art and are fed to dogs, each resulting in improved oral cavity health, including reduction in tartar or plaque and improved breath odor. For Example 8, the copper source is integrated throughout the kibble, while the zinc source is coated on the surface of the kibble (along with the palatant). For Example 9, the zinc source is integrated throughout the kibble, while the hexametaphosphate is coated on the surface of the kibble (along with the palatant).

| | Example 8 | Example 9 |
|---|---|---|
| | (Component Amount | (Component Amount |
| Component | indicated as Wt %) | indicated as Wt %) |
| Copper Sulfate | 0.03 | 0 |
| Pentahydrate | | |
| Zinc sulfate monohydrate | 0.1 | 0.15 |
| Hexametaphosphate | 0 | 0.3 |
| Palatant | 0.1 | 0.08 |
| Poultry, Poultry | 44 | 47 |
| By-product | | |
| Meal, and Fish Meal | | |
| Animal Fat | 8 | 6 |
| Beet Pulp and | 2.2 | 3 |
| fructooligosaccharide | | |
| Salts | 2.5 | 2 |
| Vitamins and Minerals* | 1 | 1 |
| Minors | 3.5 | 4 |
| Grains | Remainder | Remainder |
| (corn, sorghum, barley, | | |
| rice) | | |

*Vitamins and Minerals include: Vitamin E, beta-carotene and Vitamin A, Zinc Oxide, Ascorbic Acid, Manganese Sulfate, Copper Sulfate, Manganous Oxide, Calcium Pantothenate, Biotin, Vitamin B₁₂, Vitamin B₁, Niacin, Vitamin B₂, Vitamin B₆, Vitamin D₃, Folic Acid.

### Example 10-31

The pet composition of the present invention can be a dry animal food composition, wet animal food composition, or moist animal food composition. Compositions which may be utilized for Example 10-31 may be prepared using the following components in the indicated amounts:

Dry animal food compositions

| | Percentage % on dry matter basis (w/w) | | | | | | |
|---|---|---|---|---|---|---|---|
| | Ex. | Ex. | | Ex. | | Ex. | Ex. |
| Ingredient | 10 | 11 | Ex. 12 | 13 | Ex. 14 | 15 | 16 |
| Chicken | 43.0 | 45.0 | 50.0 | 52.0 | 52.0 | 52.0 | 53.2 |
| products and | | | | | | | |
| meals | | | | | | | |
| Cereal grains | 19.42 | 40.4 | 35.6 | 22.7 | 33.4 | 33.4 | 4.0 |
| Fat | 2.97 | 2.0 | 1.0 | 6.0 | 7.38 | 6.89 | 7.2 |
| Egg product | 2.4 | 1.5 | 3.0 | 2.0 | 2.0 | 2.0 | 2.0 |
| Vitamins | 0.4 | 0.4 | 0.4 | 0.4 | 0.3 | 0.3 | 0.3 |
| Minerals | 1.3 | 1.2 | 1.0 | 1.2 | 1.2 | 1.2 | 1.2 |
| Choline chloride | 0.3 | 0.3 | 0.3 | 0.3 | 0.3 | 0.3 | 0.3 |
| DL-Methionine | 0.2 | 0.2 | 0.1 | 0.1 | 0.1 | 0.1 | 0.1 |
| Supplemental | | | | | | | |
| fiber | | | | | | | |
| Beet pulp | 0.0 | 1.0 | 5.4 | 7.0 | 3.0 | 3.0 | 4.0 |
| Fructo- | 0.0 | 0.0 | 0.1 | 2.3 | 0.3 | 0.3 | 0.0 |
| oligosaccharide | | | | | | | |
| Nut shell | | | | | | | |
| Pecan nut | 0.0 | 0.0 | 3.0 | 5.0 | 0.01 | 0.5 | 25.0 |
| shell | | | | | | | |
| Pecan | 0.0 | 0.0 | 0.1 | 1.0 | 0.0 | 0.01 | 2.7 |
| packing tissue | | | | | | | |
| Walnut nut | 30.0 | 7.0 | 0.0 | 0.0 | 0.01 | 0.0 | 0.0 |
| shell | | | | | | | |
| Walnut | 0.01 | 1.0 | 0.0 | 0.0 | 0.0 | 0.0 | 0.0 |
| packing tissue | | | | | | | |

Wet animal food compositions

| | Percentage on dry matter basis (w/w) | | | | | | | |
|---|---|---|---|---|---|---|---|---|
| | Ex. | Ex. | Ex. | Ex. | Ex. | Ex. | Ex. | Ex. |
| Ingredient | 17 | 18 | 19 | 20 | 21 | 22 | 23 | 24 |
| Poultry and | 88.0 | 60.0 | 88.58 | 2.0 | 39.5 | 24.0 | 28.0 | 18.0 |
| meat products | | | | | | | | |
| Cereal grains | 6.9 | 27.45 | 0 | 2.0 | 24.0 | 5.5 | 28.5 | 18.0 |
| Egg Product | 2.5 | 5.6 | 1.0 | 0.5 | 0.5 | 2.5 | 3.0 | 0.5 |
| Taurine | 0.1 | 0.1 | 0 | 0.0 | 0.0 | 0.0 | 0.0 | 0.0 |
| Vitamins | 0.04 | 0.1 | 0.1 | 0.25 | 0.25 | 0.25 | 0.25 | 0.25 |
| Minerals | 0.25 | 0.2 | 0.1 | 0.25 | 0.25 | 0.25 | 0.25 | 0.25 |
| Supplemental | | | | | | | | |
| fiber | | | | | | | | |
| Beet pulp | 2.0 | 6.0 | 4.0 | 0.0 | 4.0 | 6.0 | 0.0 | 2.0 |
| Fructo- | 0.1 | 0.0 | 2.0 | 0.0 | 0.0 | 1.0 | 0.0 | 0.0 |
| oligosaccharide | | | | | | | | |
| Nut shell | | | | | | | | |
| Pecan nut | 0.1 | 0.0 | 2.0 | 86.0 | 30.0 | 55.0 | 15.0 | 0.0 |
| shell | | | | | | | | |
| Pecan | 0.01 | 0.0 | 0.2 | 9.0 | 1.5 | 5.5 | 5.0 | 0.0 |
| packing tissue | | | | | | | | |
| Walnut nut | 0.0 | 0.05 | 2.0 | 0.0 | 0.0 | 0.0 | 15.0 | 60.0 |
| shell | | | | | | | | |
| Walnut | 0.0 | 0.5 | 0.02 | 0.0 | 0.0 | 0.0 | 5.0 | 1.0 |
| packing tissue | | | | | | | | |

Moist animal food composition

| | Percentage on dry matter basis (w/w) | | | | | | |
|---|---|---|---|---|---|---|---|
| | Ex. | Ex. | | Ex. | | Ex. | Ex. |
| Ingredient | 25 | 26 | Ex. 27 | 28 | Ex. 29 | 30 | 31 |
| Poultry and fish | 44.4 | 35.0 | 28.8 | 0.0 | 14.0 | 30.0 | 52.9 |
| products | | | | | | | |
| Cereal grains | 19.5 | 30.0 | 45.0 | 2.0 | 10.0 | 19.96 | 19.5 |
| Humectants | 20.0 | 15 | 9.98 | 5.0 | 5.0 | 5.0 | 20.0 |
| Fat | 5.0 | 3.8 | 5.0 | 5.0 | 5.0 | 5.0 | 5.0 |
| Vitamins | 0.05 | 0.1 | 0.1 | 0.0 | 0.0 | 0.0 | 0.05 |
| Minerals | 0.05 | 0.1 | 0.1 | 0.0 | 0.0 | 0.0 | 0.05 |
| Supplemental | | | | | | | |
| fiber | | | | | | | |
| Beet pulp | 5.5 | 7.0 | 4.0 | 0.0 | 0.0 | 5.0 | 1.0 |
| Fructo- | 0.0 | 1.9 | 2.0 | 0.0 | 0.0 | 0.01 | 1.0 |
| oligosaccharide | | | | | | | |
| Nut shell | | | | | | | |
| Pecan nut shell | 0.0 | 7.0 | 2.5 | 80.0 | 0.0 | 35.0 | 0.5 |
| Pecan packing | 0.0 | 0.1 | 0.0 | 8.0 | 0.0 | 0.03 | 0.0 |
| tissue | | | | | | | |
| Walnut nut shell | 5.5 | 0.0 | 2.5 | 0.0 | 60.0 | 0.0 | 0.0 |
| Walnut packing | 0.0 | 0.0 | 0.02 | 0.0 | 6.0 | 0.0 | 0.0 |
| tissue | | | | | | | |

The dry animal food compositions of Examples 10, 11, 12, 13, 14, 15, and 16 can be made by first, milling and mixing the cereal grains with vitamins and minerals and supplemental fiber sources and nut shell. Then, add the cereal grains to the meat products and other protein sources. Extrude the ingredients into kibbles. Dry the kibbles.

The wet animal food compositions of Examples 17, 18, 19, 20, 21, 22, 23, and 24 can be made by first drying and milling cereal grains. Mix dried cereal grains, vitamins, minerals and supplemental fiber sources and nut shell. Blend dry ingredients with meat products and other protein sources. The mixture is packaged into cans and cooked via retort process to provided finished product. For preformed pieces (chunks in gravy) mixture is extruded, passed through a steam tunnel for preconditioning, cut to desired shape, packaged in the pet container of the present invention with added water and retorted to provide safe finished product.

The moist animal food compositions of Examples 25, 26, 27, 28, 29, 30, and 31 can be made by milling and mixing the cereal grains with vitamins and minerals and supplemental fiber sources and nut shell. Then, add the cereal grains to the meat products and other protein sources with humectants to control water activity and mold. Extrude the ingredients into desired shape. Dry the finished product.

### Example 32-33

The pet composition of the present invention can be a kibble. Two kibble compositions having the following components at the approximate indicated amounts are prepared using methods which are standard in the art and are fed to cats as a daily feed:

| | Example 32 | Example 33 |
|---|---|---|
| | (Component Amount | (Component Amount |
| Component | indicated as Wt %) | indicated as Wt %) |
| Sodium Borate | 0.06 | 0.025 |
| Chicken, Chicken By- | 44 | 47 |
| product Meal, and Fish | | |
| Meal | | |
| Chicken Fat | 8 | 6 |
| Beet Pulp | 2 | 3 |
| Salts | 2.5 | 2 |
| Vitamins and Minerals* | 1 | 1 |
| Minors | 3.5 | 4 |
| Grains | Remainder | Remainder |
| (corn, sorghum) | | |

*Vitamins and Minerals include: Vitamin E, beta-carotene and Vitamin A, Zinc Oxide, Ascorbic Acid, Manganese Sulfate, Copper Sulfate, Manganous Oxide, Calcium Pantothenate, Biotin, Vitamin B₁₂, Vitamin B₁, Niacin, Vitamin B₂, Vitamin B₆, Vitamin D₃, Folic Acid.

### Example 34-35

The pet composition of the present invention can be a kibble. Two kibble compositions having the following components at the approximate indicated amounts are prepared using methods which are standard in the art, including extrusion, and are fed to cats as a daily feed:

| | Example 34 | Example 35 |
|---|---|---|
| | (Component | (Component |
| | Amount indicate | Amount indicate |
| Component | Wt %) | Wt %) |
| Extract of Avocado Prepared | 0.02 | 0.01 |
| Accordance with Present Inve | | |
| Chicken, Chicken By-product | 44 | 47 |
| Meal, and Fish Meal | | |
| Chicken Fat | 8 | 6 |
| Beet Pulp | 2 | 3 |
| Salts | 2.5 | 2 |
| Vitamins and Minerals** | 1 | 1 |
| Minors | 3.5 | 4 |
| Grains | Remainder | Remainder |
| (corn, sorghum) | | |

*Avocado may be substituted with other plant matter having enhanced mannoheptulose content.
**Vitamins and Minerals include: Vitamin E, beta-carotene and Vitamin A, Zinc Oxide, Ascorbic Acid, Manganese Sulfate, Copper Sulfate, Manganous Oxide, Calcium Pantothenate, Biotin, Vitamin B₁₂, Vitamin B₁, Niacin, Vitamin B₂, Vitamin B₆, Vitamin D₃, Folic Acid.

### Example 36-37

The pet composition of the present invention can be a kibble. Two kibble compositions having the following components at the approximate indicated amounts are prepared using methods which are standard in the art, including extrusion, and are fed to cats as a daily feed:

| | Example 36 | Example 37 |
|---|---|---|
| | (Component | (Component |
| | Amount indicate | Amount indicate |
| Component | Wt %) | Wt %) |
| Extract of Avocado | 0.02 | 0.01 |
| Chicken, Chicken By-product | 44 | 47 |
| Meal, and Fish Meal | | |
| Chicken Fat | 8 | 6 |
| Beet Pulp | 2 | 3 |
| Salts | 2.5 | 2 |
| Vitamins and Minerals** | 1 | 1 |
| Minors | 3.5 | 4 |
| Grains | Remainder | Remainder |
| (corn, sorghum) | | |

*Avocado may be substituted with other plant matter having enhanced mannoheptulose content.
**Vitamins and Minerals include: Vitamin E, beta-carotene and Vitamin A, Zinc Oxide, Ascorbic Acid, Manganese Sulfate, Copper Sulfate, Manganous Oxide, Calcium Pantothenate, Biotin, Vitamin B₁₂, Vitamin B₁, Niacin, Vitamin B₂, Vitamin B₆, Vitamin D₃, Folic Acid.

### Example 38

The pet composition of the present invention can be a gravy. A beef-flavor gravy composition is prepared by combining the following components in a conventional manner:

| Component | Wt % |
|---|---|
| Sodium Borate | 0.5 |
| Chicken Fat | 3.0 |
| Spray-Dried Beef Particles and Broth | 3.0 |
| Xanthan Gum | 0.5 |
| Flax Seed | 0.2 |
| Vegetables | 0.2 |
| Vitamins | 0.06 |
| Minerals | 0.04 |
| Phosphoric Acid | 0.95 |
| Beef Flavor | 0.1 |
| Water | Remainder |

*Vitamins and Minerals include: Vitamin E, beta-carotene and Vitamin A, Zinc Oxide, Ascorbic Acid, Manganese Sulfate, Copper Sulfate, Manganous Oxide, Calcium Pantothenate, Biotin, Vitamin B₁₂, Vitamin B₁, Niacin, Vitamin B₂, Vitamin B₆, Vitamin D₃, Folic Acid.

One fluid ounce of the gravy composition is admixed with one-half cup of standard dog kibble diet daily prior to feeding to a dog. Amounts of the gravy composition are determined as desired by the guardian of the dog.

### Example 39

The pet composition of the present invention can be a gravy. A beef-flavor gravy composition is prepared by combining the following components in a conventional manner:

| Component | Wt % |
|---|---|
| Extract of Avocado Prepared in Accordance with Present | 0.14 |
| Inven | |
| Chicken Fat | 3.0 |
| Spray-Dried Beef Particles and Broth | 3.0 |
| Xanthan Gum | 0.5 |
| Flax Seed | 0.2 |
| Vegetables | 0.2 |
| Vitamins** | 0.06 |
| Minerals | 0.04 |
| Phosphoric Acid | 0.95 |
| Beef Flavor | 0.1 |
| Water | Remainder |

**Vitamins and Minerals include: Vitamin E, beta-carotene and Vitamin A, Zinc Oxide, Ascorbic Acid, Manganese Sulfate, Copper Sulfate, Manganous Oxide, Calcium Pantothenate, Biotin, Vitamin B₁₂, Vitamin B₁, Niacin, Vitamin B₂, Vitamin B₆, Vitamin D₃, Folic Acid.

One fluid ounce of the gravy composition is admixed with one-half cup of standard dog kibble diet daily prior to feeding to a dog. Amounts of the gravy composition are determined as desired by the guardian of the dog

### Examples 40-43

The pet composition of the present invention can be a kibble. Examples 37 to 40 are examples of dried kibble compositions comprising the probiotic Bifidobacteria globosum.

| | Percentage on a weight Basis | | | |
|---|---|---|---|---|
| Ingredient | Ex. 40 | Ex. 41 | Ex. 42 | Ex. 43 |
| Cereal grains | To 100 | To 100 | To 100 | To 100 |
| Poultry by-product meal | 43.5 | 40 | 45 | 35 |
| Poultry fat | 1.28 | 1.02 | 1.16 | 1.35 |
| Egg product | 2.4 | 2.1 | 2.5 | 2.2 |
| Chicken liver meal | 1.0 | 1.0 | 1.0 | 1.0 |
| Brewer's dried yeast | 1.0 | 1.0 | 1.0 | 1.0 |
| Monosodium phosphate | 1.0 | 1.0 | 1.0 | 1.0 |
| Calcium carbonate | 0.8 | 0.8 | 0.8 | 0.8 |
| Potassium chloride | 0.6 | 0.6 | 0.6 | 0.6 |
| Vitamins | 0.4 | 0.4 | 0.4 | 0.4 |
| Choline chloride | 0.3 | 0.3 | 0.3 | 0.3 |
| Minerals | 0.3 | 0.3 | 0.3 | 0.3 |
| DL-Methionine | 0.1 | 0.1 | 0.1 | 0.1 |
| Sodium Chloride | 0.03 | 0.03 | 0.03 | 0.03 |
| Probiotic (1 × 10¹⁰ cfu/g | 1 | 0.5 | — | 0.6 |
| NCIMB 41198 in sunflower | | | | |
| oil) | | | | |
| Probiotic (1 × 10¹⁰ cfu/g | — | 0.5 | 1 | 0.4 |
| NCIMB 41199 in sunflower | | | | |
| oil) | | | | |

### Example 44-46

Examples 44 to 46 are examples of wet pet food compositions comprising the probiotic Bifidobacteria globosum utilized in accordance with the present invention.

| | Percentage on a | | |
|---|---|---|---|
| | weight Basis | | |
| Ingredient | Ex. 44 | Ex. 45 | Ex. 46 |
| Water | To 38 | To 47 | To 50 |
| Poultry Liver | To 25 | To 20 | To 15 |
| Poultry Products | 25 | 20 | 20 |
| Brewers Rice | 5 | 7 | 10 |
| Egg Product | 3 | 2.5 | 1.5 |
| Poultry Fat | 2.9 | 3.0 | 3.2 |
| Chicken Stock | 0.6 | 0.7 | 0.9 |
| Taurine | 0.1 | 0.1 | 0.1 |
| Vitamins | 0.05 | 0.1 | 0.1 |
| Minerals | 0.05 | 0.1 | 0.1 |
| Probiotic NCIMB41003 | 4 | 5 | 6 |
| (1E10 CFU/g) | | | |

### Examples 47-49

Examples 47 to 49 are examples of yogurt supplement compositions comprising the probiotic Bifidobacteria globosum utilized in accordance with the present invention.

| | Percentage on a | | |
|---|---|---|---|
| | weight Basis | | |
| Ingredient | Ex. 47 | Ex. 48 | Ex. 49 |
| Milk | 82.75 | 81.9 | 82.7 |
| Sugar | 12 | 12 | 10 |
| Modified Starch | 1.0 | 0.8 | 0.8 |
| Prebiotic | 0.25 | 0.3 | 0.5 |
| Probiotic NCIMB 41052 | 4 | 5 | 6 |
| (1E10 CFU/g) | | | |

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A pet container comprising: a base comprising at least two legs; and wherein said container has a tip angle of from about 10° to about 50°.

2. The pet container of claim 1, wherein said container has a tip angle of from about 15° to about 45°.

3. The pet container of claim 1, wherein said container has a tip angle of from about 20° to about 40°.

4. The pet container of claim 1, wherein said container has a tip angle of from about 25° to about 35°.

5. The pet container of claim 1, wherein said legs extend from said base.

6. The pet container of claim 1, wherein said legs support said container in an upright position.

7. The pet container of claim 1, wherein said legs prevent tipping of said container.

8. The pet container of claim 1, wherein said container has a geometric shape.

9. The pet container of claim 1, further comprising a handle.

10. The pet container of claim 1, further comprising an orifice.

11. The pet container of claim 1, further comprising an orifice cover.

12. The pet container of claim 1, wherein said container comprises a pet composition contained in said container.

13. The pet container of claim 12, wherein said composition is selected from the group consisting of pet food, dog food, cat food, treats, biscuits, kitty liter, catnip, toys, raw hide, shampoos, conditioners, treats, probiotics, vitamins, and combinations thereof.

14. The pet container of claim 12, wherein said pet composition is wet, dry and/or moist.

15. A pet container comprising: a base comprising at least three legs; and wherein said container has a tip angle of from about 10’ to about 50°.

16. The pet container of claim 15, wherein said container has a tip angle of from about 15° to about 45°.

17. The pet container of claim 15, wherein said container has a tip angle of from about 20° to about 40°.

18. The pet container of claim 15, wherein said container has a tip angle of from about 25° to about 35°.

19. The pet container of claim 15, wherein said legs extend from said base.

20. The pet container of claim 15, wherein said legs support said container in an upright position.

21. The pet container of claim 15, wherein said legs prevent tipping of said container.

22. The pet container of claim 15, wherein said container has a geometric shape.

23. The pet container of claim 15, further comprising a handle.

24. The pet container of claim 15, further comprising an orifice.

25. The pet container of claim 15, further comprising an orifice cover.

26. The pet container of claim 15, wherein said container comprises a pet composition.

27. The pet container of claim 26, wherein said composition is selected from the group consisting of pet food, dog food, cat food, treats, biscuits, kitty liter, catnip, toys, raw hide, shampoos, conditioners, treats, probiotics, vitamins, and combinations thereof.

28. The pet container of claim 26, wherein said pet composition is wet, dry and/or moist.

29. A pet container comprising: a base comprising at least four legs; and wherein said container has a tip angle of from about 10° to about 50°.

30. The pet container of claim 29, wherein said container has a tip angle of from about 15° to about 45°.

31. The pet container of claim 29, wherein said container has a tip angle of from about 20° to about 40°.

32. The pet container of claim 29, wherein said container has a tip angle of from about 25° to about 35°.

33. The pet container of claim 29, wherein said legs extend from said base.

34. The pet container of claim 29, wherein said legs support said container in an upright position.

35. The pet container of claim 29, wherein said legs prevent tipping of said container.

36. The pet container of claim 29, wherein said container has a geometric shape.

37. The pet container of claim 29, further comprising a handle.

38. The pet container of claim 29, further comprising an orifice.

39. The pet container of claim 29, further comprising an orifice cover.

40. The pet container of claim 29, wherein said container comprises a pet composition.

41. The pet container of claim 40, wherein said composition is selected from the group consisting of pet food, dog food, cat food, treats, biscuits, kitty liter, catnip, toys, raw hide, shampoos, conditioners, treats, probiotics, vitamins, and combinations thereof.

42. The pet container of claim 40, wherein said pet composition is wet, dry and/or moist.

43. A pet kit comprising: (a) an article of commerce comprising a pet container comprising a base and two legs and a pet composition contained in the container; and (b) a handle.

44. The pet kit of claim 43, further comprising a set of instructions.

45. The pet kit of claim 43, further comprising an additional pet composition

46. A method of dispensing a pet composition from a pet container, the method comprising the steps of:
(a) removing a orifice cover from an orifice of a pet container;
(b) dispensing a pet composition from said pet container comprising a base comprising at least two legs wherein said container has a tip angle of from about 10° to about 50°; and
(c) closing said pet container with said orifice cover.

47. An article of commerce comprising:
(a) a pet container having a base with two legs;
(b) a pet composition contained in said container having a base with two legs; and
(c) a set of instructions in association with said container comprising instructions to open, pour and close said container; and
wherein said container allows for easy dispensing of said composition.
